(19) United States
(12) Patent Application Publication
(10) Pub. No.: US 2026/0084710 A1
(43) Pub. Date: Mar. 26, 2026

(54) CONTROL DEVICE, CONTROL METHOD, AND NON-TRANSITORY COMPUTER-READABLE STORAGE MEDIUM

(71) Applicant: HONDA MOTOR CO., LTD., Tokyo (JP)

(72) Inventor: Yuki HARA, Tokyo (JP)

(73) Assignee: HONDA MOTOR CO., LTD., Tokyo (JP)

(21) Appl. No.: 19/330,251

(22) Filed: Sep. 16, 2025

(30) Foreign Application Priority Data
Sep. 20, 2024 (JP) 2024-163329

(51) Int. Cl. B60W 50/14; B60W 30/06; G06V 20/58; G08G 1/14

(52) U.S. Cl. CPC B60W 50/14; B60W 30/06; G06V 20/586; G08G 1/143; B60W 2050/143; B60W 2050/146; B60W 2420/403; B60W 2510/18; B60W 2520/10; B60W 2540/18; B60W 2540/215

(57) ABSTRACT

A vehicle has a control device which autonomously selects a target parking position based on external environment recognition information around the vehicle, controls to display the target parking position to an occupant of the vehicle, controls the vehicle to autonomously park at the target parking position when a braking operation of the vehicle is released after receiving a parking start operation from the occupant, and controls an informing unit to inform the occupant. The control device receives a change operation from the occupant for changing the target parking position. In a state in which the parking start operation is not received, the control device controls the informing unit not to inform the occupant in a case where the braking operation is released without receiving the change operation, and controls the informing unit to inform the occupant in a case where the braking operation is released after receiving the change operation.

### CROSS-REFERENCE TO RELATED APPLICATIONS

This application is based on and claims priority under 35 USC 119 from Japanese Patent Application No. 2024-163329 filed on Sep. 20, 2024, the entire content of which is incorporated herein by reference.

### TECHNICAL FIELD

The present disclosure relates to a control device, a control method, and a non-transitory computer-readable storage medium storing a control program.

### BACKGROUND ART

In recent years, active efforts have been made to provide access to a sustainable transportation system in consideration of vulnerable people among traffic participants. In order to implement the above, research and development on further improving safety and convenience of traffic by research and development related to driving assistance technology have been focused on.

In the related art, there has been known an automated parking system that automatically parks a vehicle in a designated predetermined parking space. In such an automated parking system, the system presents parking position candidates for the vehicle, and a user selects a target parking position at which to park the vehicle from among the candidates. In order to eliminate trouble of selecting the target parking position from among the parking position candidates, a predetermined target parking position may be selected and presented by the system.

For example, JP2022-184506A describes a parking assistance device that recognizes landmark information indicating a feature of a place where the vehicle is to be parked based on sensing information from a periphery monitoring sensor, and stores path information in a form of a periphery map such as a home map including not only a parking path during automated parking but also the landmark information during the automated parking, and uses the path information including landmarks in estimating a host vehicle position.

However, when an automated parking system is activated, in order to alert a driver, an alarm is often informed, for example, each time a brake is released until a predetermined operation to start automated parking is received from the driver. However, some of these alarms are unnecessary for the driver, and many drivers do not want to be informed of all of these alarms. When the user selects a target parking position from among presented parking position candidates, the user may mistakenly believe that the operation of selecting the target parking position has initiated the automated parking and release a braking operation, causing the vehicle to perform creep traveling while the user is still in the mistaken belief, and therefore, call for attention is required. JP2022-184506A does not disclose any measures to address these issues.

### SUMMARY OF INVENTION

An object of the present disclosure is to provide a control device, a control method, and a non-transitory computer-readable storage medium storing a control program that enable to prevent a user from being unnecessarily informed while notifying the user of danger associated with releasing a braking operation. This hence contributes to development of a sustainable transportation system.

A first aspect of the present disclosure relates to a control device of a vehicle, the control device configured to:
autonomously select a target parking position based on external environment recognition information around the vehicle;
control to display the target parking position to an occupant of the vehicle on a display unit;
control the vehicle to autonomously park at the target parking position when a braking operation of the vehicle is released after receiving a parking start operation from the occupant; and
control an informing unit to inform the occupant, in which
the control device is allowed to receive a change operation from the occupant for changing the target parking position, and
in a state in which the parking start operation is not received, the control device controls the informing unit not to inform the occupant in a case where the braking operation is released without receiving the change operation, and controls the informing unit to inform the occupant in a case where the braking operation is released after receiving the change operation.

A second aspect of the present disclosure relates to a control method for a vehicle, in which
a control device of the vehicle is configured to:
   autonomously select a target parking position based on external environment recognition information around the vehicle;
   control to display the target parking position to an occupant of the vehicle;
   control the vehicle to autonomously park at the target parking position when a braking operation of the vehicle is released after receiving a parking start operation from the occupant; and
   receive a change operation from the occupant for changing the target parking position, and
in a state in which the parking start operation is not received, the control device controls not to inform the occupant in a case where the braking operation is released without receiving the change operation, and controls to inform the occupant in a case where the braking operation is released after receiving the change operation.

A third aspect of the present disclosure relates to a non-transitory computer-readable storage medium storing a control program for a vehicle, in which
the control program causes a processor of a control device of the vehicle to:
   autonomously select a target parking position based on external environment recognition information around the vehicle;
   control to display the target parking position to an occupant of the vehicle;
   control the vehicle to autonomously park at the target parking position when a braking operation of the vehicle is released after receiving a parking start operation from the occupant; and
   receive a change operation from the occupant for changing the target parking position, and
in a state in which the parking start operation is not received, the control device controls not to inform the occupant in a case where the braking operation is released without receiving the change operation, and controls to inform the occupant in a case where the braking operation is released after receiving the change operation.

The present disclosure can provide a control device, a control method, and a control program that enable to prevent a user from being unnecessarily informed while notifying the user of danger associated with releasing a braking operation.

### BRIEF DESCRIPTION OF DRAWINGS

Exemplary embodiment(s) of the present invention will be described in detail based on the following figures, wherein:

FIG. 1 is a side view of an example of a vehicle 10 equipped with a control device of the present disclosure;

FIG. 2 is a top view of the vehicle 10 illustrated in FIG. 1;

FIG. 3 is a block diagram illustrating an example of an internal configuration of the vehicle 10 illustrated in FIG. 1;

FIG. 4 is a flowchart illustrating an example of processing performed by a control ECU 20 during parking assistance of the vehicle 10;

FIG. 5 is a diagram illustrating an example of a notification screen 70 for notifying of a target parking position 71 of the vehicle 10;

FIG. 6 is a diagram illustrating an example of a guide display 81 of a parking start operation for starting parking by parking assistance;

FIG. 7 is a diagram illustrating an example of an informing screen 91 for calling attention to traveling of the vehicle 10;

FIG. 8 is a sequence diagram illustrating a first operation example of the vehicle 10 during the parking assistance in response to an operation by a user U1;

FIG. 9 is a sequence diagram illustrating a second operation example of the vehicle during the parking assistance in response to an operation by the user U1;

FIG. 10 is a sequence diagram illustrating a third operation example of the vehicle during the parking assistance in response to an operation by the user U1;

FIG. 11 is a sequence diagram illustrating a fourth operation example of the vehicle during the parking assistance in response to an operation by the user U1; and

FIG. 12 is a flowchart illustrating a modification of the processing performed by the control ECU 20 during the parking assistance of the vehicle 10.

### DESCRIPTION OF EMBODIMENTS

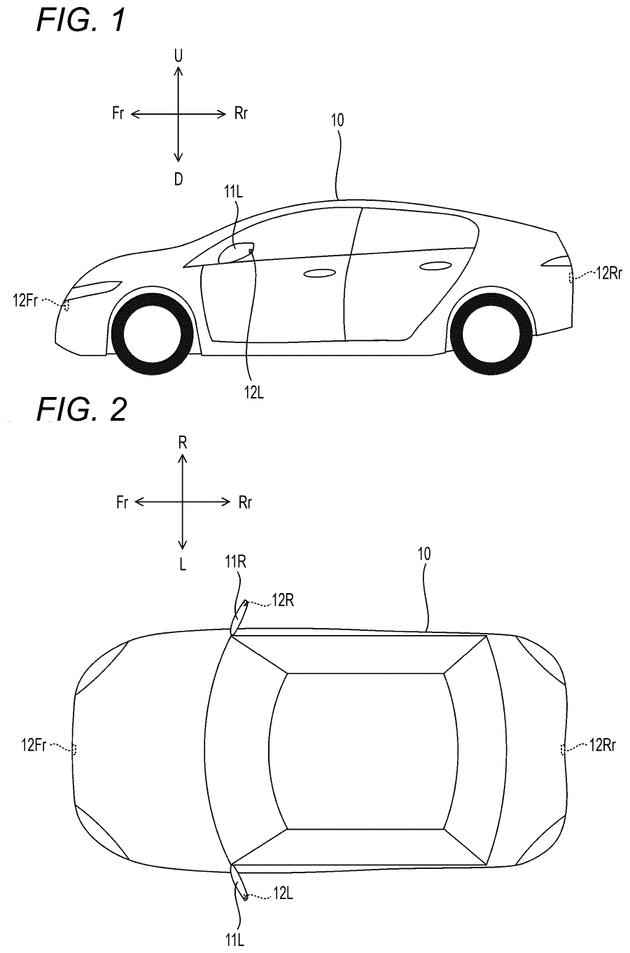

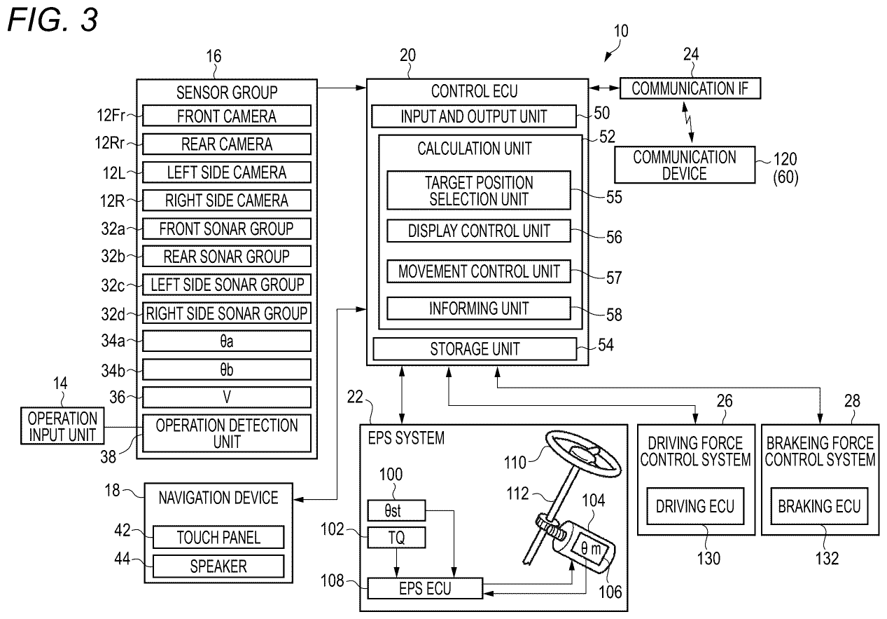

Hereinafter, an embodiment of a control device, a control method, and a control program of the present disclosure will be described with reference to the accompanying drawings. The drawings are viewed in directions of reference numerals. In order to simplify and clarify the description in the present specification or the like, a front-rear direction, a left-right direction, and an upper-lower direction are described according to directions viewed from a driver of a vehicle 10 illustrated in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

<Vehicle 10 Equipped with Control Device of Present Disclosure>

FIG. 1 is a side view of an example of the vehicle 10 equipped with a control device of the present disclosure. FIG. 2 is a top view of the vehicle 10 illustrated in FIG. 1.

The vehicle 10 is an automobile including a drive source (not illustrated) and wheels including drive wheels driven by power of the drive source and steerable steered wheels. In the present embodiment, the vehicle 10 is a four-wheeled automobile including a pair of left and right front wheels and a pair of left and right rear wheels. The drive source of the vehicle 10 is, for example, an electric motor. The drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by pivoting about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### <Internal Configuration of Vehicle 10>

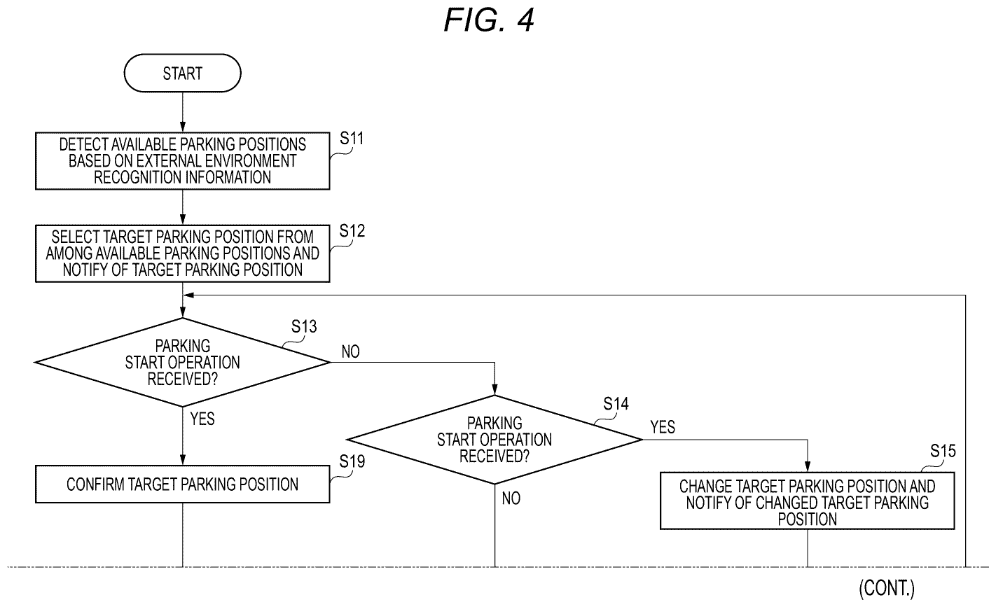

FIG. 3 is a block diagram illustrating an example of an internal configuration of the vehicle 10 illustrated in FIG. 1. As illustrated in FIG. 3, the vehicle 10 includes a sensor group 16, a navigation device 18, a control electronic control unit (control ECU) 20, an electric power steering (EPS) system 22, and a communication interface (IF) 24. The vehicle 10 further includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire external environment recognition information (for example, peripheral images) for recognizing surroundings of the vehicle 10 by capturing images of a periphery of the vehicle 10. The peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the periphery of the vehicle, which is generated by combining the images captured by the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control ECU 20. The operation input unit 14 includes various user interfaces such as a side mirror switch that switches the side mirrors 11L and 11R between opened and closed states, and a shift lever (a selector lever or a selector).

The navigation device 18 detects a current position of the vehicle 10 by using, for example, a global positioning system (GPS), and guides the user along a path to a destination. The navigation device 18 includes a storage device (not shown) including a map information database. The navigation device 18 also includes a touch panel 42 and a speaker 44. The touch panel 42 functions as an input device and a display device of the control ECU 20. The speaker 44 outputs various types of guidance information to the user of the vehicle 10 by sound.

The touch panel 42 is configured to enable various commands to be input to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes a remote parking button for requesting parking by automatic steering of the control ECU 20, and a parking support button for requesting support while parking the vehicle by an operation of the user. The exiting assistance button includes a remote exiting button for requesting exiting by the automatic steering of the control ECU 20, and a support exiting button for requesting support while exiting by an operation of the user. Note that a constituent element other than the touch panel 42, for example, an information terminal such as a smartphone or a tablet may be used as the input device or the display device.

Note that the “parking” is synonymous with, for example, “park”. For example, the “parking” is a stop as the user gets on and off the vehicle, and excludes a temporary stop due to a traffic signal or the like. Further, a “parking position” is a position where the moving object (vehicle 10) is stopped, that is, a position where the moving object (vehicle 10) is parked.

The control ECU 20 includes an input and output unit 50, a calculation unit 52, and a storage unit 54. The calculation unit 52 is implemented by, for example, a Central Processing Unit (CPU). The calculation unit 52 executes various types of control by controlling units based on a program stored in the storage unit 54. Further, the calculation unit 52 receives and outputs signals from and to units connected to the control ECU 20 via the input and output unit 50. The storage unit 54 also stores information related to remote movement (remote entering and exiting) of the vehicle 10. The control ECU 20 is an example of a “control device”.

The calculation unit 52 includes a target position selection unit 55 that selects a target parking position of the vehicle 10, a display control unit 56 that controls to display the target parking position of the vehicle 10 on a display unit, a movement control unit 57 that parks the vehicle 10 at the target parking position, and an informing unit 58 that informs the user (for example, an “occupant”) of the vehicle 10.

The target position selection unit 55 autonomously selects the target parking position of the vehicle 10 based on the external environment recognition information around the vehicle 10. The expression of “autonomously selects the target parking position of the vehicle 10” means selecting the target parking position from among a plurality of parking position candidates (available parking positions) where the vehicle 10 can be parked, without receiving an operation that explicitly instructs the target parking position.

The target position selection unit 55 detects available parking positions where the vehicle 10 can be parked based on the external environment recognition information, and selects the target parking position, which is a target position where the vehicle 10 is to be parked, from among the detected available parking positions. Conditions for selecting the target parking position from among the available parking positions include, for example, a distance from a current position of the vehicle 10 to the target parking position, a current orientation of the vehicle 10 relative to the target parking position, a load on the EPS system 22 when calculating a parking track of the vehicle 10 to the target parking position or a time until parking completion, and user setting. The user setting refers to, for example, setting a parking position as the user's favorite, or prioritizing a large parking space, a parking space close to a destination, a space with no other vehicles parked on either side, or the like. The target parking position may be determined by weighting or scoring the selected condition items.

When the user performs a change operation to change the target parking position of the vehicle 10 selected by the target position selection unit 55 to the other target parking position, the target position selection unit 55 can receive the change operation, and autonomously reselects the target parking position when receiving the change operation. The “change operation” is an operation for changing the target parking position among the available parking positions. The “change operation” can be performed, for example, by operating a button or a touch panel. However, the change operation for changing the target parking position cannot be received when a braking operation of the vehicle 10 is released.

In a state in which a parking start operation performed by, for example, pressing a parking assistance button of the vehicle 10 is not received from the user of the vehicle 10, the target position selection unit 55 waits for the braking operation and autonomously reselects the target parking position of the vehicle 10 based on the external environment recognition information in a case where the braking operation of the vehicle 10 is released after receiving the change operation for changing the target parking position of the vehicle 10 from the user. The expression of “waits for the braking operation” refers to a case where the braking operation which is released after the change operation is received is then performed again. The target position selection unit 55 may cancel (invalidate) the target parking position that has been set up when the braking operation is released.

The display control unit 56 controls to display, on the display unit, to the user of the vehicle 10, the available parking positions detected by the target position selection unit 55 and the target parking position selected from among the available parking positions by the target position selection unit 55. The display unit is, for example, the touch panel 42 of the navigation device 18. The display control unit 56 receives the change operation for changing the target parking position of the vehicle 10 by an operation performed by the user on the display unit. The display control unit 56 receives the parking start operation for starting parking assistance of the vehicle 10 by an operation performed by the user on the display unit. The parking assistance button that is pressed to start the parking assistance of the vehicle 10 is, for example, a soft button displayed on the touch panel 42. Convenience is improved by making it possible to change the target parking position using the same touch panel as the touch panel 42 on which the available parking positions are displayed. Use of the touch panel 42, which also allows adjustment of other items, improves operability.

The movement control unit 57 performs remote parking assistance and remote exiting assistance of the vehicle 10 through automatic steering in which a steering 110 is automatically operated under control of the movement control unit 57. In the remote parking assistance and the remote exiting assistance, an accelerator pedal (not shown), a brake pedal (not shown), and the operation input unit 14 are automatically operated. The movement control unit 57 performs parking support assistance and exiting support assistance when the user (driver) operates the accelerator pedal, the brake pedal, and the operation input unit 14 to perform manual parking and manual exiting of the vehicle 10. Note that during the remote parking assistance and the remote exiting assistance, the driver may be in a state of being present in the vehicle 10, or may be in a state of getting off the vehicle 10 and being outside (not being present in the vehicle).

For example, the movement control unit 57 performs the movement control for executing movement of the vehicle 10 based on the external environment recognition information of the vehicle 10 acquired from the front camera 12Fr, the rear camera 12Rr, the left side camera 12L, and the right side camera 12R, and a specified predetermined parking space. The movement control includes parking control for remotely parking the vehicle 10 at a predetermined parking space (target parking position) and exiting control for remotely causing the vehicle 10 to exit from a parking space to a predetermined exit space (target exit position).

When the braking operation of the vehicle 10 is released after receiving the parking start operation from the user, the movement control unit 57 performs the movement control to autonomously park the vehicle 10 at the target parking position. The “parking start operation” refers to, for example, pressing the parking assistance button while keeping stepping on the brake. The “braking operation” refers to an operation of stepping on the brake.

In a state in which the parking start operation of the vehicle 10 is not received, the informing unit 58 does not inform the user in a case where the braking operation of the vehicle 10 is released without receiving the change operation for changing the target parking position of the vehicle 10. In a state in which the parking start operation of the vehicle 10 is not received, the informing unit 58 informs the user in a case where the braking operation of the vehicle 10 is released after receiving the change operation for changing the target parking position of the vehicle 10. The informing unit 58 cancels the informing to the user based on at least one of an elapsed time from start of the informing, the braking operation performed after the start of the informing, a moving speed of the vehicle 10, or steering of the steering 110. The informing may be performed by, for example, at least one of display on the touch panel 42 of the navigation device 18, sound output from the speaker 44, or lighting of an indicator. The informing is, for example, an alarm that informs the user of danger.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for the user's operation on the steering 110 and automatic steering during the parking assistance. The resolver 106 detects a rotation angle θm of the EPS motor 104. The EPS ECU 108 controls the entire EPS system 22. The EPS ECU 108 includes an input and output unit (not illustrated), a calculation unit (not illustrated), and a storage unit (not illustrated).

The communication IF 24 enables wireless communication with another communication device 120. Another communication device 120 includes a base station, a communication device of another vehicle, an information terminal 60 such as a smartphone or a tablet carried by the user of the vehicle 10, and the like. For example, the communication IF 24 includes an ultra wide band (UWB, registered trademark) interface or the like that can execute UWB communication with the information terminal 60. The communication IF 24 transmits and receives information regarding remote parking/exiting and parking/exiting support of the vehicle 10 to and from the information terminal 60 and the like.

The driving force control system 26 includes a driving ECU 130. The driving force control system 26 executes driving force control of the vehicle 10. The driving ECU 130 controls a driving force of the vehicle 10 by controlling an engine or the like (not shown) based on an operation performed by the user on the accelerator pedal (not shown).

The braking force control system 28 includes a braking ECU 132. The braking force control system 28 executes braking force control of the vehicle 10. The braking ECU 132 controls a braking force of the vehicle 10 by controlling a brake mechanism or the like (not illustrated) based on an operation by the user on a brake pedal (not illustrated).

### <Processing of Control ECU 20>

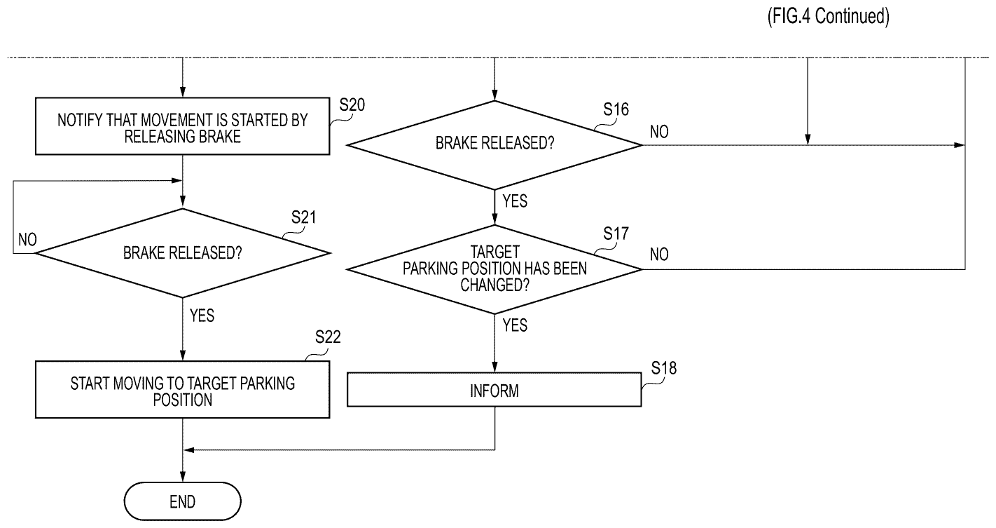

FIG. 4 is a flowchart illustrating an example of processing performed by the control ECU 20 during parking assistance of the vehicle 10. This processing is executed in a case where the parking assistance button for requesting the parking assistance of the vehicle 10 is pressed and the vehicle 10 is stopped. That is, this processing is started with the brake of the vehicle 10 being stepped on.

When the parking assistance button is pressed and a parking assistance system is started, the control ECU 20 detects available parking positions where the vehicle 10 can be parked based on the external environment recognition information of the vehicle 10 acquired by the front camera 12Fr, the rear camera 12Rr, the left side camera 12L, and the right side camera 12R (step S11).

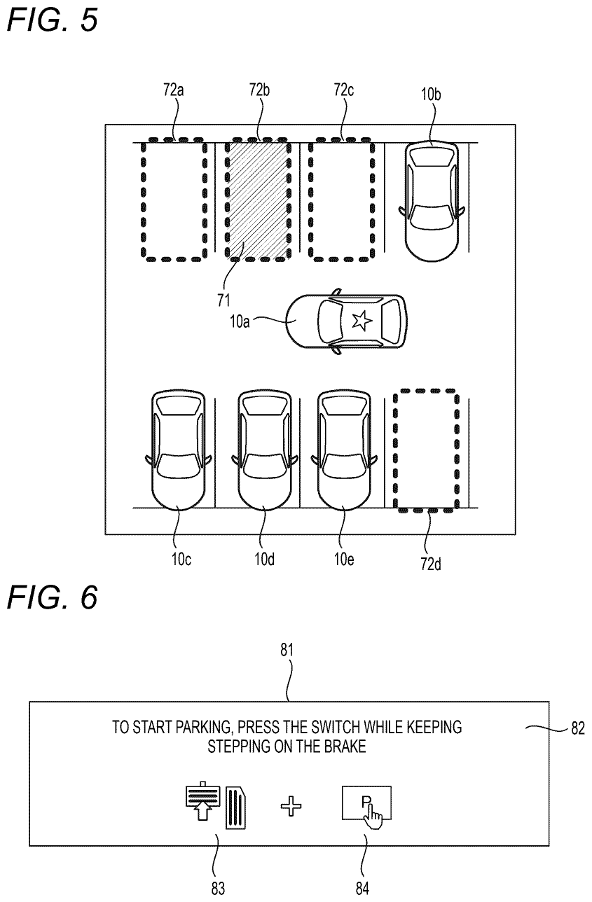

Next, the control ECU 20 selects the target parking position where the vehicle 10 is to be parked from among the available parking positions detected in step S11, and notifies the user (occupant) of the vehicle 10 of the selected target parking position (step S12). The notification of the target parking position is performed by, for example, displaying the peripheral image of the vehicle 10, the available parking positions, and the target parking position on a screen of the navigation device 18. The screen for notifying of the target parking position will be described later with reference to FIG. 5.

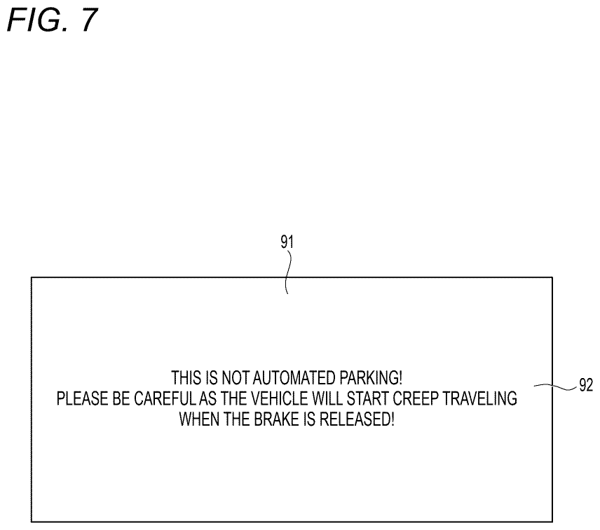

Next, the control ECU 20 determines whether the parking start operation for starting parking of the vehicle 10 by parking assistance is received (step S13). Whether the parking start operation is received is determined based on whether, for example, a parking start switch which instructs the start of parking, is pressed. The reception of the parking start operation will be described later with reference to FIG. 6.

In step S13, if the parking start operation is not received (step S13: No), the control ECU 20 determines whether or the change operation for changing the target parking position is received (step S14). Changing the target parking position includes changing the target parking position selected and notified in step S12, and changing the target parking position to be changed and notified in step S15. The change operation for changing the target parking position can be performed, for example, via a notification screen of the target parking position, which will be described later with reference to FIG. 5. Note that if the braking operation of the vehicle 10 is released under this case, the change operation for changing the target parking position may not be received.

In step S14, if the change operation for changing the target parking position is received (step S14: Yes), the control ECU 20 changes the target parking position to a position after the change operation and notifies the user of the vehicle 10 of the changed target parking position (step S15). After notifying of the changed target parking position, the control ECU 20 returns to step S13 and executes the processing of each step.

In step S14, if the change operation for changing the target parking position is not received (step S14: No), the control ECU 20 determines whether the brake of the vehicle 10 is released (step S16). In step S16, if the brake is not released (step S16: No), the control ECU returns to step S13 and executes the processing of each step.

In step S16, if the brake is released (step S16: Yes), the control ECU 20 determines whether the target parking position has been changed by the change operation (step S17). In step S17, if the target parking position has not been changed (step S17: No), the control ECU returns to step S13 and executes the processing of each step.

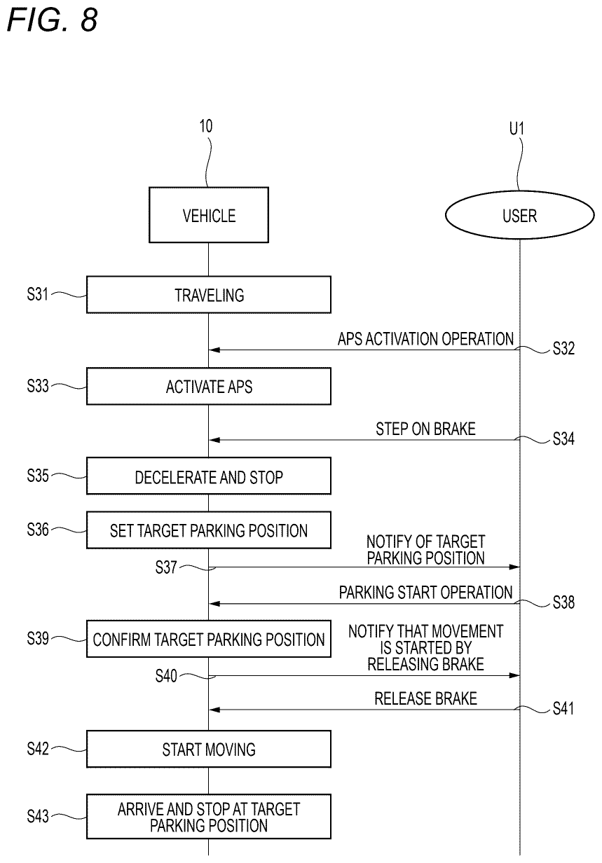

In step S17, if the target parking position has been changed (step S17: Yes), the control ECU 20 informs the user of the vehicle 10 of an attention to traveling of the vehicle (step S18), and ends this processing. An informing content will be described later with reference to FIG. 7.

Note that when the user performs, for example, a braking operation in response to the informing from the vehicle 10 and the vehicle stops, the control ECU 20 cancels the informing and starts the processing from step S11.

In step S13, if the parking start operation is received (step S13: Yes), the control ECU 20 confirms the selected target parking position as the target parking position of the vehicle 10 (step S19).

The control ECU 20 notifies the user that the vehicle 10 will start moving by releasing the stepped brake (step S20).

The control ECU 20 determines whether the brake of the vehicle 10 is released (step S21), and if the brakes is not released, repeats the processing of step S21, and if the brake is released, starts movement to the target parking position (step S22). Note that if the brake of the vehicle 10 is stepped again while the vehicle 10 is moving to the target parking position, the control ECU 20 stops the vehicle 10.

### <Notification Screen of Target Parking Position>

FIG. 5 is a diagram illustrating an example of a notification screen 70 for notifying of a target parking position 71 of the vehicle 10. The notification screen 70 of the target parking position 71 is displayed on the touch panel 42 of the navigation device 18, for example. Note that in FIG. 5, the vehicle to be parked at the target parking position 71 is displayed as a host vehicle 10a, and vehicles already parked in predetermined parking spaces are displayed as other vehicles 10b, 10c, 10d, and 10e. The target parking position 71 is displayed on the peripheral image showing the surroundings of the host vehicle 10a, together with available parking positions 72a, 72b, 72c, and 72d where the vehicle 10a can be parked. The target parking position 71 is a target parking position of the vehicle 10a selected from among the available parking positions 72a, 72b, 72c, and 72d. In the present example, the available parking position 72b is selected as the target parking position 71 of the vehicle 10a. The target parking position 71 is a target parking position selected by the control ECU 20, and it is also possible to change the target parking position 71 to one of the other available parking position 72a, 72c, or 72d by, for example, touching the touch panel 42. The notification screen 70 of the target parking position 71 illustrated in FIG. 5 is an example of the notification screen notified in step S12 of FIG. 4.

### <Guide Display of Parking Start Operation>

FIG. 6 is a diagram illustrating an example of a guide display 81 of the parking start operation for starting parking by parking assistance. The guide display 81 of the parking start operation is displayed on, for example, the touch panel 42 of the navigation device 18. The guide display 81 displays a message 82 showing an operating procedure for starting parking, such as “To start parking, press the switch while keeping stepping on the brake”, a brake image 83 showing stepping on the brake, and a switch image 84 showing the parking start switch to be pressed. The guide display 81 illustrated in FIG. 6 is displayed, for example, after the notification screen 70 of the target parking position 71 illustrated in FIG. 5, or displayed together with the notification screen 70.

### <Informing Screen>

FIG. 7 is a diagram illustrating an example of an informing screen 91 for calling attention to the traveling of the vehicle 10. The informing screen 91 is displayed on, for example, the touch panel 42 of the navigation device 18. The informing screen 91 displays a message 92 informing the user of danger, such as “This is not automated parking! Please be careful as the vehicle will start creep traveling when the brake is released!”. The informing screen 91 illustrated in FIG. 7 is an example of a screen that is displayed when the brake is released after the target parking position is changed, for example, as in step S18 in FIG. 4, without the parking start operation (FIG. 6) being performed.

### <Vehicle Operation in Response to User Operation>

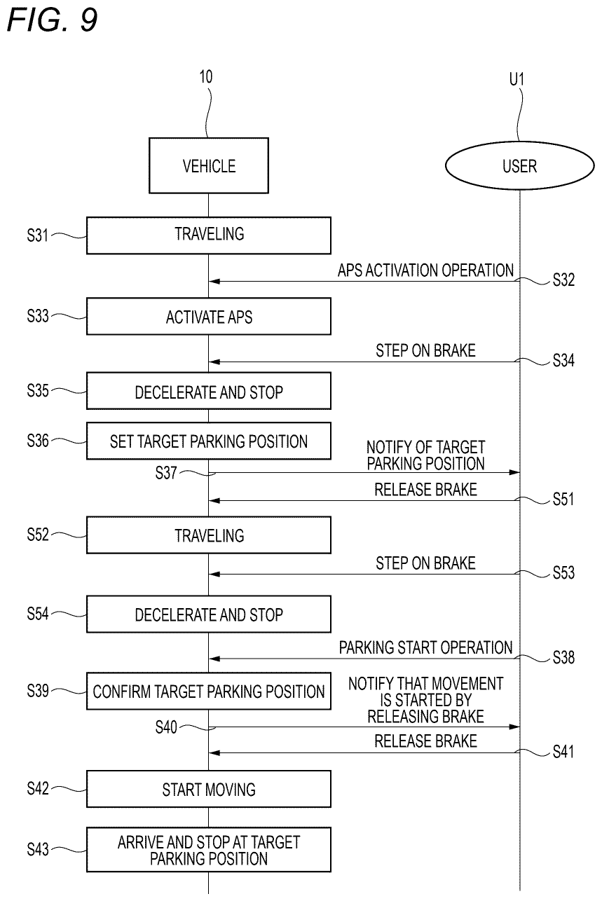

FIG. 8 is a sequence diagram illustrating a first operation example of the vehicle 10 during the parking assistance in response to an operation by a user U1.

It is assumed that the vehicle 10 is traveling (step S31). The vehicle 10 arrives at, for example, a shopping mall and the vehicle 10 is to be parked at a parking lot of the shopping mall.

The user U1 activates an Automated Parking System (APS) for performing parking control of the vehicle 10 by parking assistance (step S32). For example, the user U1 presses the parking assistance button for requesting parking assistance.

The vehicle 10 activates the APS based on the APS activation operation from the user U1 (step S33). The vehicle 10 starts acquiring the external environment recognition information using the front camera 12Fr, the rear camera 12Rr, the left side camera 12L, and the right side camera 12R.

The user U1 steps on the brake to stop the traveling of the vehicle 10 (step S34).

The vehicle 10 decelerates and stops based on the braking operation of the user U1 (step S35). In the present example, the APS is activated by performing the APS activation operation, and then the brake is stepped to decelerate and stop the vehicle, but the order may be reversed. That is, the APS may be activated by performing the APS activation operation after the brake is stepped to decelerate and stop the vehicle.

Based on the external environment recognition information acquired in step S33, the vehicle 10 detects available parking positions of the vehicle 10 in the parking lot, selects a target parking position where the vehicle 10 is to be parked from among the detected available parking positions, and sets the selected position as the target parking position of the vehicle (step S36). The vehicle 10 notifies the user U1 of the set target parking position (step S37). The set target parking position is notified as, for example, the target parking position 71 as illustrated in FIG. 5. At this time, the target parking position is notified and a guide for starting parking of the vehicle 10, as illustrated in FIG. 6 for example, is displayed.

In the first operation example, a case where the user U1 has known the target parking position set by the vehicle 10 will be described. For example, the user U1 performs the parking start operation of pressing the parking start switch to start parking the vehicle 10 by parking assistance (step S38).

Based on the parking start operation from the user U1, the vehicle 10 confirms the target parking position set in step S36 as the target parking position of the vehicle 10 (step S39). The vehicle 10 notifies the user U1 that the vehicle 10 will start moving by releasing the brake of the vehicle 10 that the user U1 is stepping (step S40).

Based on the notification in step S40, the user U1 releases the braking operation of the vehicle 10 (step S41).

As the brake is released, the vehicle 10 starts moving toward the confirmed target parking position (step S42). When the vehicle 10 arrives at the target parking position, the vehicle 10 stops at the target parking position (step S43).

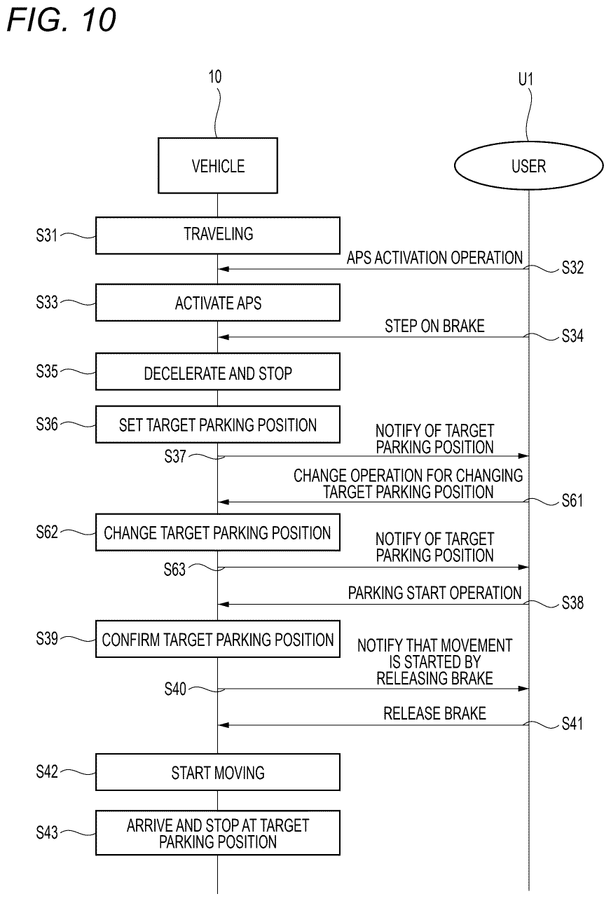

FIG. 9 is a sequence diagram illustrating a second operation example of the vehicle during the parking assistance in response to an operation by the user U1.

The processing from step S31 to step S37 as illustrated in FIG. 9 is similar to the processing from step S31 to step S37 in the first operation example illustrated in FIG. 8.

Next, in the first operation example described above, in response to the notification of the target parking position, the user U1 performs the parking start operation to start parking the vehicle 10 by parking assistance (step S38 in FIG. 8). In contrast, in the second operation example, the user U1 releases the braking operation of the vehicle 10 without performing the parking start operation (step S51). For example, the user U1 releases the braking operation of the vehicle 10 to confirm by himself or herself a target parking position other than the notified target parking position.

In this case, since the parking start operation is not performed to start parking the vehicle 10 by parking assistance, the vehicle 10 starts traveling due to the brake being released (step S52).

Next, the user U1 steps on the brake to stop the traveling of the vehicle 10 (step S53).

The vehicle 10 decelerates and stops based on the braking operation of the user U1 (step S54).

In a state in which the vehicle 10 is stopped, the user U1 performs a parking start operation to start parking the vehicle 10 by parking assistance (step S38). This parking start operation is similar to the parking start operation of step S38 in the first operation example (FIG. 8) described above, and is a parking start operation performed by the user U1 after knowing the target parking position (step S37) notified by the vehicle 10. This parking start operation is a parking start operation performed when, for example, the user U1 causes the vehicle 10 to travel for confirming by himself or herself a target parking position other than the notified target parking position, but does not find a parking space he or she likes, and attempts to park the vehicle 10 at the target parking position notified by the vehicle 10.

The processing from step S39 to step S43 is similar to the processing from step S39 to step S43 in the first operation example illustrated in FIG. 8.

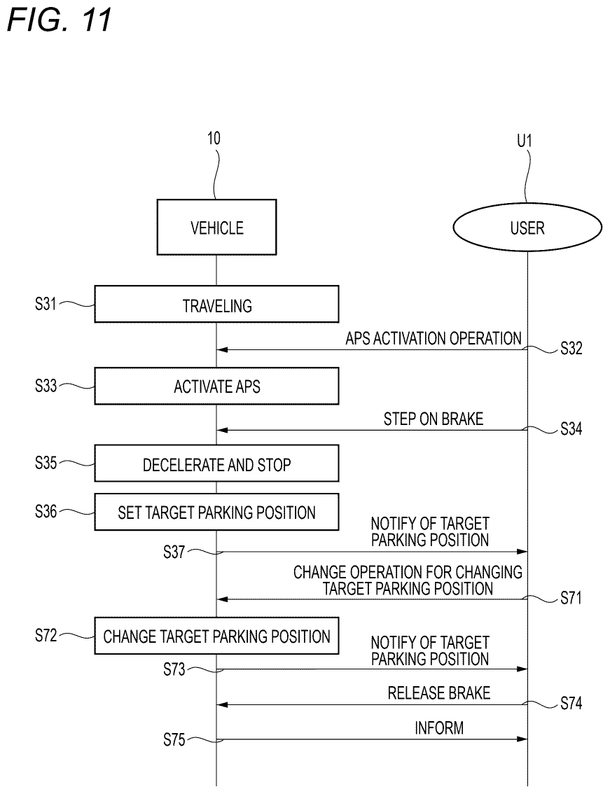

FIG. 10 is a sequence diagram illustrating a third operation example of the vehicle during the parking assistance in response to an operation by the user U1.

The processing from step S31 to step S37 as illustrated in FIG. 10 is similar to the processing from step S31 to step S37 in the first operation example illustrated in FIG. 8.

Next, in the first operation example described above, in response to the notification of the target parking position, the user U1 knows the target parking position and performs the parking start operation to start parking the vehicle 10 by parking assistance (step S38 in FIG. 8). In contrast, the third operation example is a case where the user U1 is unable to know the target parking position notified by the vehicle 10. The user U1 performs a change operation for changing the target parking position of the vehicle 10 (step S61). The change operation can be performed by selecting from among the available parking positions (see FIG. 5) where the vehicle 10 can be parked as described above.

The vehicle 10 changes the target parking position of the vehicle 10 to the position after the change operation (step S62). The vehicle 10 notifies the user U1 of the changed target parking position (step S63).

The user U1 performs a parking start operation to start parking the vehicle 10 by parking assistance (step S38). This parking start operation is a parking start operation performed by the user U1 after knowing the target parking position after the change operation notified by the vehicle 10.

The processing from step S39 to step S43 is similar to the processing from step S39 to step S43 in the first operation example illustrated in FIG. 8.

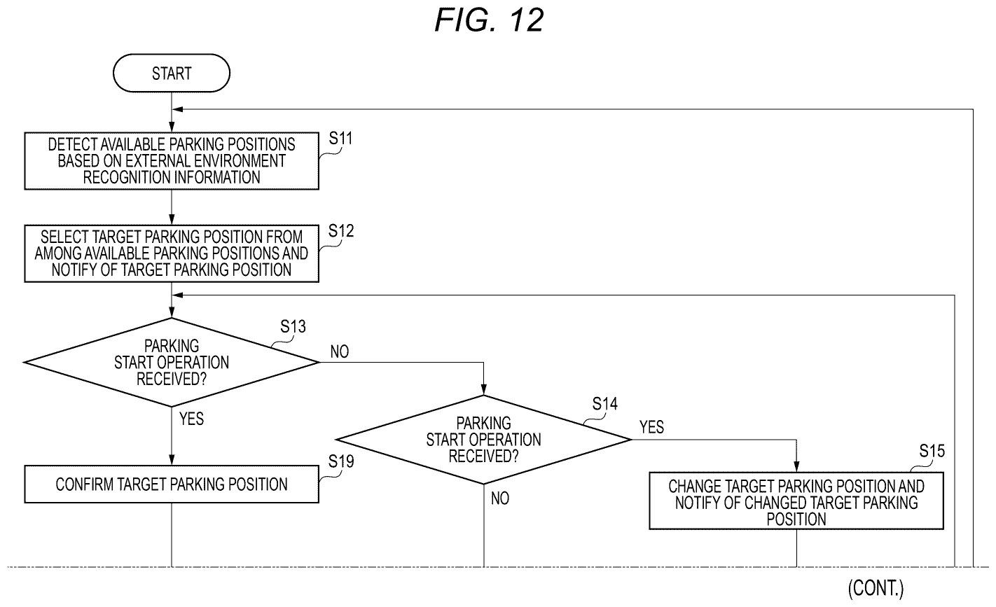

FIG. 11 is a sequence diagram illustrating a fourth operation example of the vehicle during the parking assistance in response to an operation by the user U1.

The processing from step S31 to step S37 as illustrated in FIG. 11 is similar to the processing from step S31 to step S37 in the first operation example illustrated in FIG. 8.

Next, the user U1 performs a change operation for changing the target parking position notified by the vehicle 10 (step S71). This is a change operation performed in a case where the user U1 is unable to know the target parking position notified by the vehicle 10, for example.

The vehicle 10 changes the target parking position of the vehicle 10 to the position after the change operation (step S72). Then, the vehicle 10 notifies the user U1 of the changed target parking position (step S73). The processing from step S71 to step S73 in the fourth operation example is similar to the processing from step S61 to step S63 in the third operation example described with reference to FIG. 10.

Next, in the case of the third operation example described above, in response to the notification of the changed target parking position, the user U1 performs the parking start operation to start parking the vehicle 10 by parking assistance (step S38 in FIG. 10). In contrast, in the fourth operation example, the user U1 releases the braking operation of the vehicle 10 without performing the parking start operation (step S74).

The vehicle 10 informs the user U1 for calling attention to the traveling when the user U1 performs the change operation for changing the target parking position and releases the braking operation without performing the parking start operation on the vehicle 10 (step S75). The informing for calling attention is displayed, for example, as the informing screen 91 as illustrated in FIG. 7.

As described above, the control device of the present embodiment controls the vehicle 10 to autonomously park at the target parking position when the braking operation of the vehicle 10 is released after receiving the parking start operation from the user based on the parking assistance of the vehicle 10, and in the state in which the parking start operation from the user is not received, in the case where the braking operation is released without receiving the change operation from the user for changing the target parking position of the vehicle 10, the control device does not inform the user for calling his or her attention to the traveling, and in the case where the braking operation is released after receiving the change operation for changing the target parking position, the control device informs the user for calling his or her attention to the traveling. According to this configuration, the user is informed only when the braking operation is released after receiving the change operation for changing the target parking position without receiving the parking start operation, and therefore, it is possible to prevent the user from being unnecessarily informed while notifying the user of danger associated with releasing the braking operation. As a result, for example, when the user performs the change operation for changing the target parking position, even if the user mistakenly believes that the change operation has caused the parking start operation of the vehicle 10, the user will be informed when the braking operation is released, thereby preventing a situation in which the vehicle 10 continues creep traveling due to the false recognition of the user. Even if the user is notified of the target parking position selected by the vehicle 10, and the user releases the braking operation and causes the vehicle to move and travel within the parking lot, for example, without performing the change operation for changing the target parking position, annoyance of being informed every time the braking operation is released can be avoided.

According to the control device, available parking positions of the vehicle 10 are detected based on the external environment recognition information, a target parking position is selected from among the available parking positions, and the available parking positions and the target parking position are displayed on the navigation device 18, and when the user wishes to change the target parking position, the target parking position can be changed from among the displayed available parking positions, and therefore, it is easy to perform the change operation for changing the target parking position and good operability is provided.

According to the control device, in the state in which the braking operation of the vehicle 10 is released, the change operation for changing the target parking position of the vehicle 10 is not received. In this way, in controlling the parking assistance of the vehicle 10, it is preferable that the change operation for changing the target parking position is received only when the user performs the braking operation and stops the vehicle 10.

According to the control device, even in the case where the braking operation is released after receiving the change operation for changing the target parking position in the state in which the parking start operation of the vehicle 10 is not received, the vehicle 10 will autonomously reselect the target parking position if the braking operation is performed then. In this way, the user is notified of the reselected target parking position while being informed that the braking operation has been released without the parking start operation being performed but with the change operation for changing the target parking position being performed, and therefore, the user can be prompted to perform a parking start operation of the vehicle 10 to the reselected target parking position.

### <Modification of Processing of Control ECU 20>

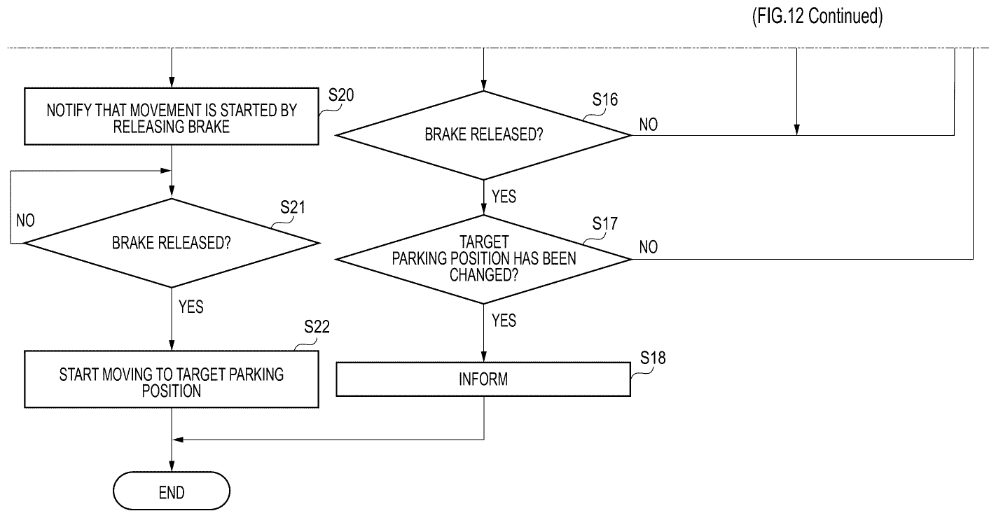

FIG. 12 is a flowchart illustrating a modification of the processing performed by the control ECU 20 during the parking assistance of the vehicle 10. The processing from step S11 to step S22 in the present modification is similar to the processing from step S11 to step S22 in the example described with reference to FIG. 4. However, in the present modification, if the target parking position has not been changed in step S17 (step S17: No), the control ECU returns to step S11 and executes the processing of each step. In this respect, the processing in the present modification differs from the processing in FIG. 4 in which the control ECU returns to step S13 and executes the processing of each step if the target parking position has not been changed. That is, in the present modification, even after the control ECU 20 selects the target parking position and notifies the user of the selected target parking position, in a case where the user does not perform the parking start operation of the vehicle 10 and does not perform the change operation for changing the target parking position, and releases the braking operation of the vehicle 10, the control ECU returns to step S11, detects available parking positions based on new external environment recognition information, and reselects the target parking position in step S12. According to this configuration, since the vehicle 10 moves and the position thereof changes when the braking operation is released, by returning to step S11, detecting the available parking positions based on external environment recognition information corresponding to the movement and selecting a target parking position, it becomes possible to notify the user of a preferred target parking position.

The control method described in the above embodiment may be implemented by executing a control program prepared in advance on a computer. The control program is stored in a computer-readable storage medium and executed by being read from the storage medium. Further, the control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

Although the embodiment of the present disclosure has been described above, the present invention is not limited to the above-described embodiment, and modifications, improvements, and the like can be appropriately made.

In the above-described embodiment, an example in which the moving object is a vehicle (four-wheeled automobile) has been described, but the moving object is not limited thereto. For example, the moving object may be a vehicle such as a two-wheeled vehicle or a Segway. Further, the idea of the present invention is not limited to the vehicle, and may also be applied to a robot, a ship, an aircraft, or the like that includes a drive source and is movable by power of the drive source.

In the present specification, at least the following matters are described. In the parentheses, the corresponding constituent elements and the like in the above embodiment are shown, but the present invention is not limited thereto.

(1) A control device (control ECU 20) of a vehicle (vehicle 10), the control device configured to:
autonomously select (target position selection unit 55) a target parking position based on external environment recognition information around the vehicle;
control to display the target parking position to an occupant of the vehicle on a display unit (touch panel 42);
control (movement control unit 57) the vehicle to autonomously park at the target parking position when a braking operation of the vehicle is released after receiving a parking start operation from the occupant; and
control an informing unit (informing unit 58) to inform the occupant, in which
the control device is allowed to receive a change operation from the occupant for changing the target parking position, and
in a state in which the parking start operation is not received, the control device controls the informing unit not to inform the occupant in a case where the braking operation is released without receiving the change operation, and controls the informing unit to inform the occupant in a case where the braking operation is released after receiving the change operation.

According to (1), the occupant is informed only when the braking operation is released after receiving the change operation for changing the target parking position in the state in which the parking start operation is not received, and therefore, it is possible to prevent the occupant from being unnecessarily informed while notifying the occupant of danger associated with releasing the braking operation.

(2) The control device according to (1), in which
the control device detects available parking positions based on the external environment recognition information and selects the target parking position from among the available parking positions,
the display unit displays the available parking positions and the target parking position, and
the change operation is an operation of changing the target parking position among the available parking positions.

According to (2), the target parking position can be selected from among the available parking positions of the vehicle displayed on the display unit, and therefore, the target parking position can be easily changed.

(3) The control device according to (1) or (2), in which
the change operation is not received in a state in which the braking operation is released.

As in (3), in a case of autonomous parking of the vehicle, it is preferable not to receive the change operation for changing the target parking position in the state in which the braking operation is released.

(4) The control device according to any one of (1) to (3), in which
in the state in which the parking start operation is not received, the control device waits for the braking operation and autonomously reselects the target parking position based on the external environment recognition information in the case where the braking operation is released after receiving the change operation.

According to (4), even in the case where the braking operation is released after receiving the change operation for changing the target parking position in the state in which the parking start operation is not received, the vehicle will autonomously reselect the target parking position if the braking operation is performed then, and therefore, the occupant can be prompted to perform a parking start operation of the vehicle to the reselected target parking position.

(5) The control device according to any one of (1) to (4), in which
the display unit receives the change operation.

According to (5), the target parking position can be changed by the display unit, thereby providing good operability.

(6) The control device according to any one of (1) to (5), in which
the display unit receives the parking start operation.

According to (6), the parking start operation of the vehicle can be performed by the display unit, thereby providing good operability.

(7) The control device according to any one of (1) to (6), in which
the control device controls the informing unit to cancel the informing based on at least one of an elapsed time from a start of the informing, the braking operation, a moving speed of the vehicle, or steering of the vehicle.

According to (7), since informing can be canceled based on a predetermined condition even when the informing is started, it is not necessary to perform an operation to cancel the informing every time the occupant is informed, thereby providing convenience.

(8) The control device according to any one of (1) to (7), in which
the informing is performed by at least one of screen display, sound output, or lighting of an indicator.

According to (8), it is easy for the occupant to realize that the occupant is being informed.

(9) The control device according to any one of (1) to (8), in which
the informing is an alarm that informs the occupant of danger.

According to (9), it is possible to prevent the occupant from being unnecessarily informed while notifying the occupant of the danger associated with releasing the braking operation, by informing the occupant of occurrence of a dangerous traveling state.

(10) A control method for a vehicle, in which
a control device of the vehicle is configured to:
   autonomously select a target parking position based on external environment recognition information around the vehicle;
   control to display the target parking position to an occupant of the vehicle;
   control the vehicle to autonomously park at the target parking position when a braking operation of the vehicle is released after receiving a parking start operation from the occupant; and
   receive a change operation from the occupant for changing the target parking position, and
in a state in which the parking start operation is not received, the control device controls not to inform the occupant in a case where the braking operation is released without receiving the change operation, and controls to inform the occupant in a case where the braking operation is released after receiving the change operation.

According to (10), the occupant is informed only when the braking operation is released after receiving the change operation for changing the target parking position in the state in which the parking start operation is not received, and therefore, it is possible to prevent the occupant from being unnecessarily informed while notifying the occupant of danger associated with releasing the braking operation.

(11) A non-transitory computer-readable storage medium storing a control program

for a vehicle, in which
the control program causes a processor of a control device of the vehicle to:
   autonomously select a target parking position based on external environment recognition information around the vehicle;
   control to display the target parking position to an occupant of the vehicle;
   control the vehicle to autonomously park at the target parking position when a braking operation of the vehicle is released after receiving a parking start operation from the occupant; and
   receive a change operation from the occupant for changing the target parking position, and
in a state in which the parking start operation is not received, the control device controls not to inform the occupant in a case where the braking operation is released without receiving the change operation, and controls to inform the occupant in a case where the braking operation is released after receiving the change operation.

According to (11), the occupant is informed only when the braking operation is released after receiving the change operation for changing the target parking position in the state in which the parking start operation is not received, and therefore, it is possible to prevent the occupant from being unnecessarily informed while notifying the occupant of danger associated with releasing the braking operation.

What is claimed is:

1. A control device of a vehicle, the control device configured to:
autonomously select a target parking position based on external environment recognition information around the vehicle;
control to display the target parking position to an occupant of the vehicle on a display unit;
control the vehicle to autonomously park at the target parking position when a braking operation of the vehicle is released after receiving a parking start operation from the occupant; and
control an informing unit to inform the occupant, wherein
the control device is allowed to receive a change operation from the occupant for changing the target parking position, and
in a state in which the parking start operation is not received, the control device controls the informing unit not to inform the occupant in a case where the braking operation is released without receiving the change operation, and controls the informing unit to inform the occupant in a case where the braking operation is released after receiving the change operation.

2. The control device according to claim 1, wherein
the control device detects available parking positions based on the external environment recognition information and selects the target parking position from among the available parking positions,
the display unit displays the available parking positions and the target parking position, and
the change operation is an operation of changing the target parking position among the available parking positions.

3. The control device according to claim 1, wherein
the change operation is not received in a state in which the braking operation is released.

4. The control device according to claim 1, wherein
in the state in which the parking start operation is not received, the control device waits for the braking operation and autonomously reselects the target parking position based on the external environment recognition information in the case where the braking operation is released after receiving the change operation.

5. The control device according to claim 1, wherein
the display unit receives the change operation.

6. The control device according to claim 1, wherein
the display unit receives the parking start operation.

7. The control device according to claim 1, wherein
the control device controls the informing unit to cancel the informing based on at least one of an elapsed time from a start of the informing, the braking operation, a moving speed of the vehicle, or steering of the vehicle.

8. The control device according to claim 1, wherein
the informing is performed by at least one of screen display, sound output, or lighting of an indicator.

9. The control device according to claim 1, wherein
the informing is an alarm that informs the occupant of danger.

10. A control method for a vehicle, wherein
a control device of the vehicle is configured to:
autonomously select a target parking position based on external environment recognition information around the vehicle;
control to display the target parking position to an occupant of the vehicle;
control the vehicle to autonomously park at the target parking position when a braking operation of the vehicle is released after receiving a parking start operation from the occupant; and
receive a change operation from the occupant for changing the target parking position, and
in a state in which the parking start operation is not received, the control device controls not to inform the occupant in a case where the braking operation is released without receiving the change operation, and controls to inform the occupant in a case where the braking operation is released after receiving the change operation.

11. A non-transitory computer-readable storage medium storing a control program for a vehicle, wherein
the control program causes a processor of a control device of the vehicle to:
autonomously select a target parking position based on external environment recognition information around the vehicle;
control to display the target parking position to an occupant of the vehicle;
control the vehicle to autonomously park at the target parking position when a braking operation of the vehicle is released after receiving a parking start operation from the occupant; and
receive a change operation from the occupant for changing the target parking position, and
in a state in which the parking start operation is not received, the control device controls not to inform the occupant in a case where the braking operation is released without receiving the change operation, and controls to inform the occupant in a case where the braking operation is released after receiving the change operation.
